(19) United States
(12) Patent Application Publication
(10) Pub. No.: US 2013/0038724 A1
(43) Pub. Date: Feb. 14, 2013

(54) CAMERA TILT FLEX LOOP FOR HIGH FREQUENCY SIGNALS

(71) Applicant: Eric McCormick, Mannheim, PA (US)

(72) Inventor: Eric McCormick, Mannheim, PA (US)

(73) Assignees: Robert Bosch GmbH, Stuttgart (DE); Bosch Security Systems Inc., Fairport, NY (US)

(21) Appl. No.: 13/205,470

(22) Filed: Aug. 8, 2011

(51) Int. Cl. H04N 7/18

(52) U.S. Cl. 348/143; 348/E07.085

(57) ABSTRACT

A surveillance camera arrangement includes a camera assembly that is tiltable about a tilt axis and that has a first electrical connector. A flat cable includes first and second opposite ends connected to the first electrical connector and to a second electrical connector, respectively. The cable has a thickness, and a width at least twice as great as the thickness. The cable is bent into a J-shape wherein the width direction of the cable is substantially parallel to the tilt axis of the camera assembly.

### BACKGROUND OF THE INVENTION

1. Field of the Invention

The present invention relates to surveillance cameras, and, more particularly, to surveillance cameras that undergo tilt movements.

2. Description of the Related Art

Surveillance camera systems are commonly used by retail stores, banks, casinos and other organizations to monitor activities within a given area. The cameras are often provided with the capability to pan and tilt in order to acquire images over a wide domain. The tilt of the camera generally refers to the pivoting of the camera about a horizontal axis that is parallel to the floor, such that the lens of the camera may tilt between an upwardly pointing position and a downwardly pointing position. The pan of the camera refers to the rotation of the camera about a vertical axis that is perpendicular to the floor, such that the lens may scan from side to side. The cameras may also be able to zoom in order to reduce or enlarge the field of view.

A problem is that a number of camera components are subjected to forces from panning and tilting. For example, a set of electrical conductors interconnect a fixed electronic camera controller with the movable camera. As the camera undergoes tilting movements, the conductors may be twisted, which puts strain on the connectors that connect the conductors to the camera controller on one end, and to the camera on the other end. These mechanical forces may eventually cause the conductors to experience fatigue failure due to high internal stresses, or to break away from their electrical connections to the connectors.

Known digital cameras transmit video at high frequencies. Flex tape circuits provide an effective way to make high-frequency electrical connections between moving and non-moving portions of the camera. However, if the stress in the flex cable tape is not managed, inner conductive traces in the tape can fatigue and fail, interrupting or blocking the transmission of electrical signals between moving and fixed parts of the camera.

What is neither disclosed nor suggested by the prior art is a tiltable surveillance camera in which the tilting of the camera does not place a significant level of mechanical stress on the conductors that carry power and data to and from the camera, and on the connectors that connect the conductors to the camera and to the electronic camera controller.

### SUMMARY OF THE INVENTION

In one embodiment, the present invention is directed to a camera tilt flex loop arrangement that provides high frequency signal transmission from a moving camera while also managing stress that could compromise reliability. The camera may be capable of moving in order to change its field of view. The arrangement of the invention manages stress and strain in various camera elements during tilting, but may also be applied to panning.

In one embodiment, the camera controller and its connector to the flex loop are laterally offset, or “outboard,” from the pan axis of the camera such that the flex loop is arranged in a relaxed, low-stress loop or J-shape to thereby connect the camera controller to the camera.

The invention comprises, in one form thereof, a surveillance camera arrangement including a camera assembly that is tiltable about a tilt axis and that has a first electrical connector. A flat cable includes first and second opposite ends connected to the first electrical connector and to a second electrical connector, respectively. The cable has a thickness, and a width at least twice as great as the thickness. The cable is bent into a J-shape wherein the width direction of the cable is substantially parallel to the tilt axis of the camera assembly.

The invention comprises, in another form thereof, a surveillance camera arrangement including a camera assembly tiltable about a tilt axis. A flat cable includes first and second opposite ends. A first of the ends is connected to the camera assembly. A second of the ends is connected to a fixed structure. The cable has a thickness, and a width at least twice as great as the thickness. The cable is bent into a J-shape wherein the width direction of the cable is substantially parallel to the tilt axis of the camera assembly. The cable substantially surrounds the tilt axis.

The invention comprises, in yet another form thereof, a surveillance camera arrangement including a camera assembly tiltable about a tilt axis. A flat cable includes first and second opposite ends. A first of the ends has an extension oriented at a substantially right angle to a longitudinal axis of the cable. A distal end of the extension is connected to an electrical connector of the camera assembly. A proximal end of the extension is connected to an elbow of the cable. The elbow is fixedly attached to the camera assembly. A second one of the cable ends is connected to a fixed structure. The cable has a thickness, and a width at least twice as great as the thickness. The cable is bent into a J-shape wherein the width direction of the cable is substantially parallel to the tilt axis of the camera assembly.

An advantage of the present invention is that the camera tilt flex loop may provide high frequency signal transmission from a moving camera while also managing mechanical stress that could compromise reliability. Thus, the invention may provide increased longevity of critical components.

Another advantage of the present invention is that it provides a reduced vertical height of the overall surveillance camera assembly.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective, partially exploded view of one embodiment of a camera tilt flex loop arrangement of the present invention.

FIG. 2 is a block diagram of the electrical connections of the camera tilt flex loop arrangement of FIG. 1.

FIG. 3a is an enlarged, perspective view of one end of the flex loop cable of the camera tilt flex loop arrangement of FIG. 1.

FIG. 3b is a fragmentary, cross-sectional view of the flex loop cable of FIG. 3a along line 3b-3b.

FIG. 3c is a fragmentary, cross-sectional view of another embodiment of a flex loop cable suitable for use in the camera tilt flex loop arrangement of FIG. 1.

FIG. 4a is a side, schematic view of the flex loop cable and carriage shelf of the camera tilt flex loop arrangement of FIG. 1 in a tilt position wherein the camera is directed in a substantially horizontal direction.

FIG. 4b is a side, schematic view of the flex loop cable and carriage shelf of the camera tilt flex loop arrangement of FIG. 1 in a tilt position wherein the camera is directed nearly in a substantially vertically downward direction.

FIG. 5a is a perspective, partially exploded view of one embodiment of a camera pan flex loop arrangement of the present invention.

FIG. 5b is a fragmentary, cross-sectional view of the flex loop cable of FIG. 5a along line 5b-5b.

FIG. 6a is an overhead, schematic view of the flex loop cable and the upstanding wall of the carriage of the camera tilt flex loop arrangement of FIG. 5a in a fully clockwise pan position as viewed from above.

FIG. 6b is an overhead, schematic view of the flex loop cable and the upstanding wall of the carriage of the camera tilt flex loop arrangement of FIG. 5a in a fully counterclockwise pan position as viewed from above.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

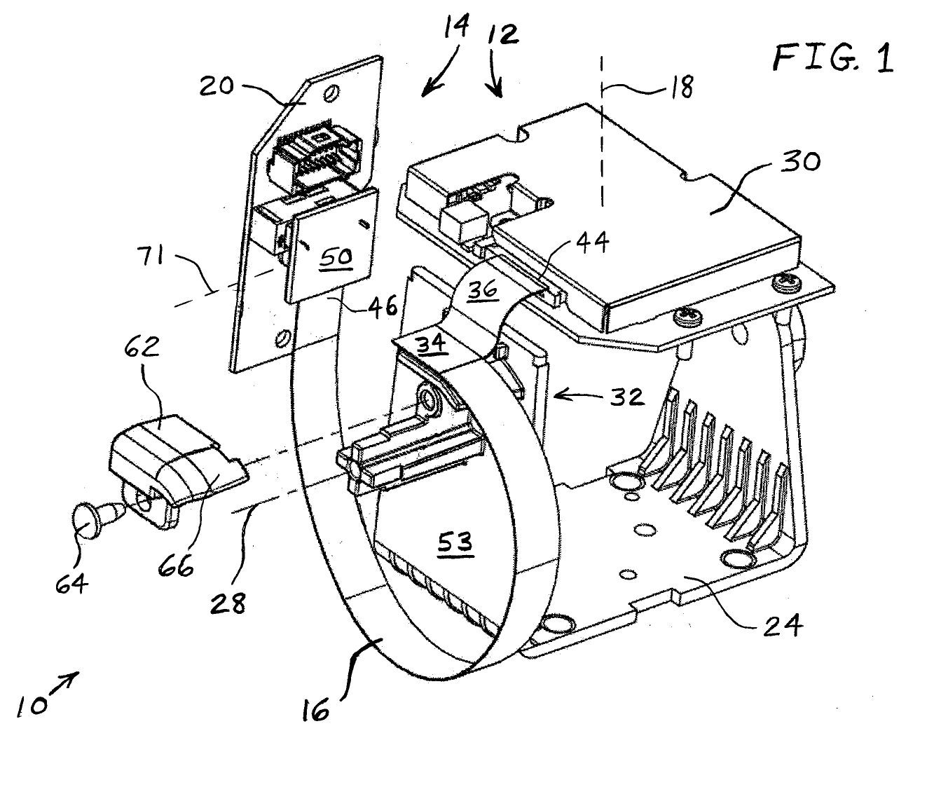

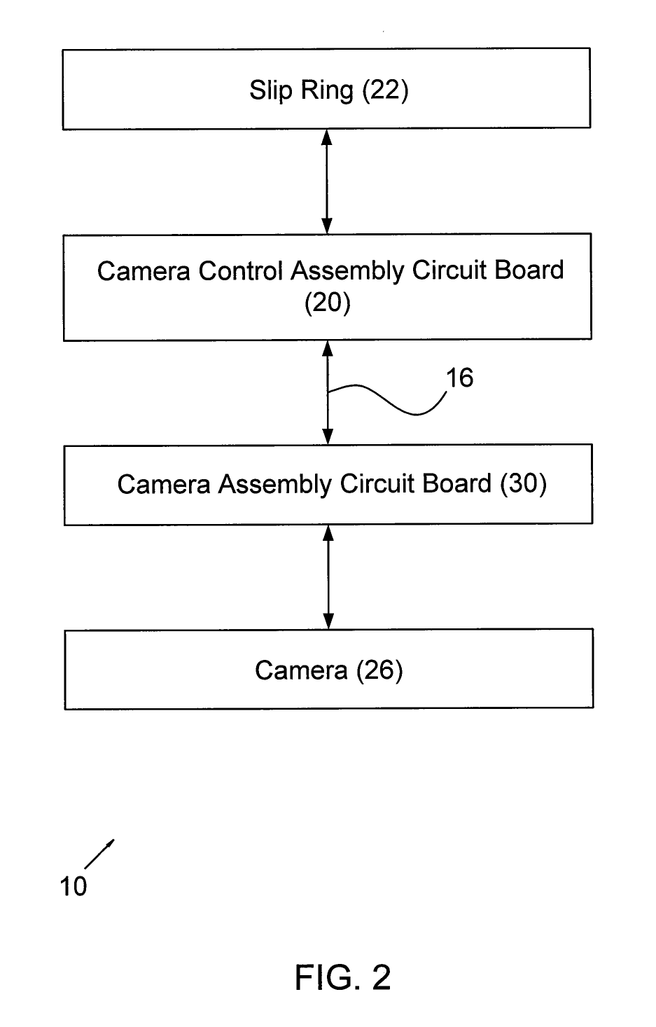

Referring now to the drawings, and particularly to FIG. 1, there is illustrated one embodiment of a camera tilt flex loop arrangement 10 of the present invention including a camera assembly 12 and a camera control assembly 14 electrically connected together by a flex loop cable 16. Camera control assembly 14 includes a circuit board 20 that may be electrically connected and/or attached to a slip ring 22 (FIG. 2) via a slip ring connector (not shown). Thus, a low stress loop in the form of cable 16 is provided between slip ring 22 and camera assembly 12. Camera control assembly 14 may be laterally offset from a pan axis 18. In one embodiment, assembly 14 is offset from pan axis 18 by four inches or more. In another embodiment, assembly 14 is offset from pan axis 18 by six inches or more. Thus, camera control assembly 14 is disposed “outboard” relative to pan axis 18. The outboard or laterally offset position of assembly 14 and the looped configuration of cable 16 provide arrangement 10 with a reduced height.

A carriage, frame or housing 24 of camera assembly 12 is fixed to camera 26 and a bearing (not shown) to rotate, pivot or tilt about a tilt axis 28. Thus, the entire camera assembly 12, including camera 26, a camera assembly circuit board 30, and carriage 24 may be tiltable in both clockwise and counterclockwise directions about tilt axis 28. Camera interface printed circuit board 30 is fixed to, and tilts with, camera 26 and camera carriage 24. In contrast with camera assembly circuit board 30, camera control assembly printed circuit board 20 may not tilt, but rather may remain stationary throughout the movement of board 30.

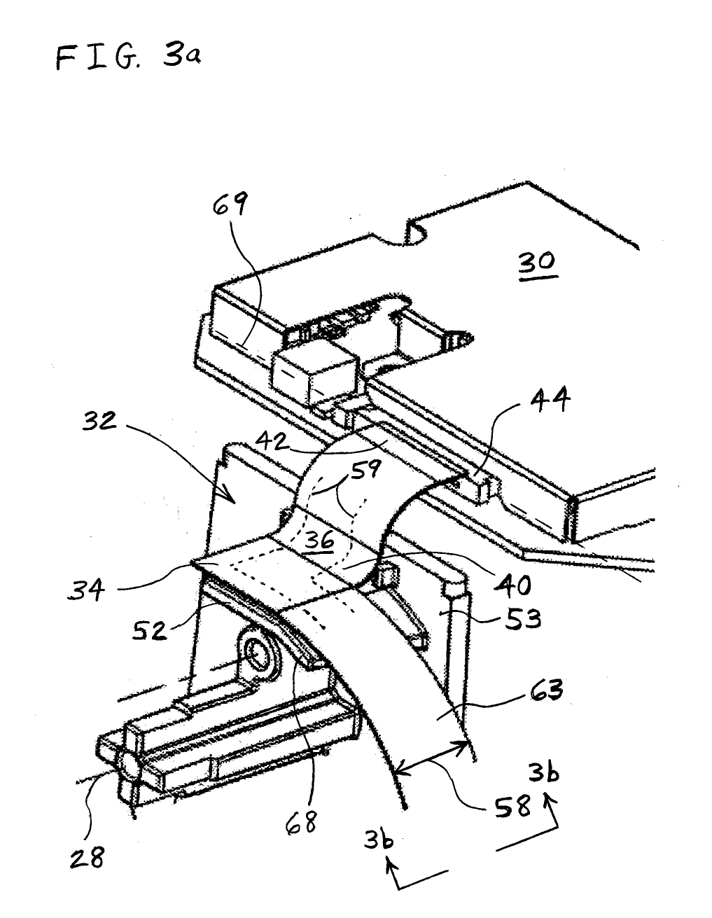

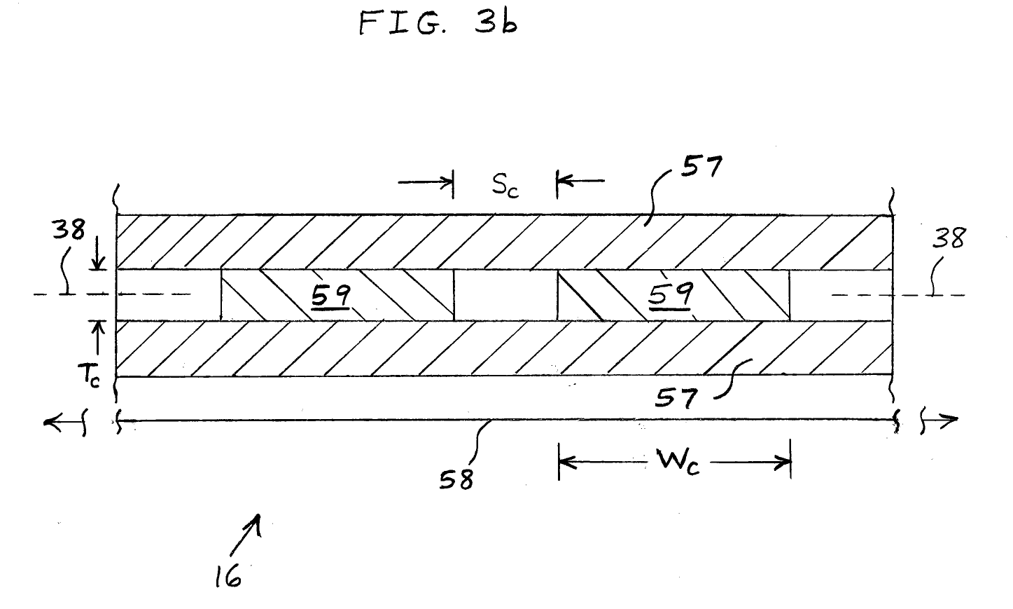

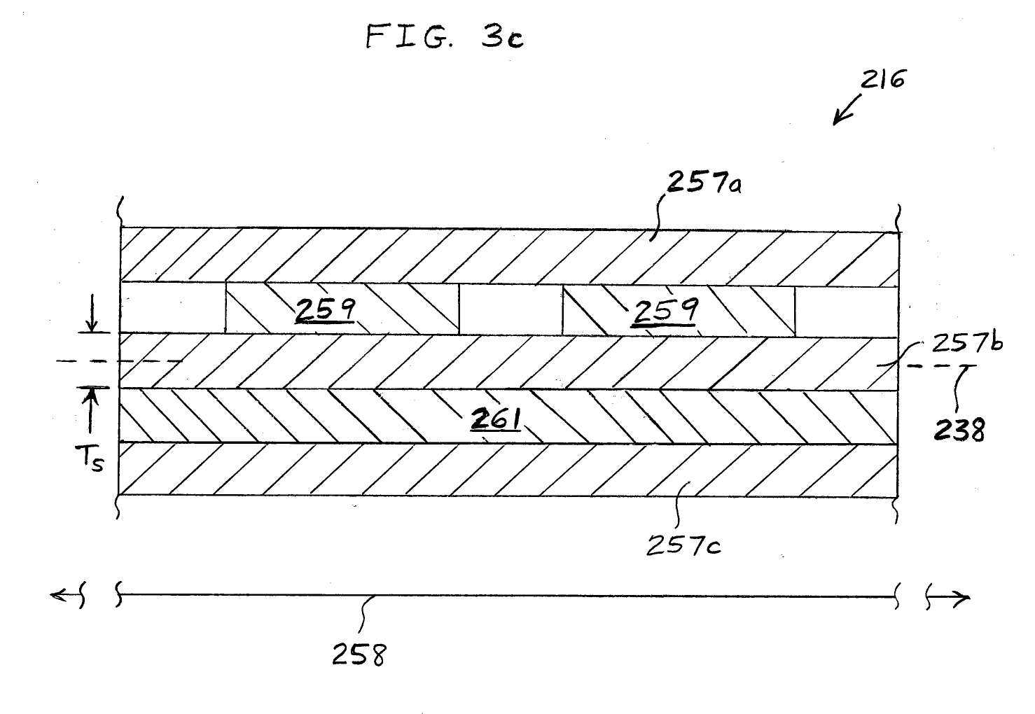

Flex loop cable 16, which may be referred to as a “flex tape circuit,” or a “flex cable tape,” engages connectors on both the camera interface and on the camera control printed circuit board. More particularly, a first end 32 of cable 16 includes an elbow 34 having an extension 36 oriented at a right angle to a longitudinal axis 38 (FIG. 3a) of cable 16. Extension 36 has a substantially serpentine profile, thereby accommodating the vertical level of elbow 34 being different than that of connector 44. In one embodiment, extension 36 is substantially S-shaped. Extension 36 has a proximal end 40 connected to a side edge of elbow 34. A distal end 42 of extension 36 is electrically connected to a connector 44 of camera assembly circuit board 30. Elbow 34 may be fixedly attached to a carriage shelf 52 that is fixedly attached to the remainder of carriage 24. In one embodiment, shelf 52 is attached to and oriented substantially perpendicular to an upstanding wall 53 of frame 24.

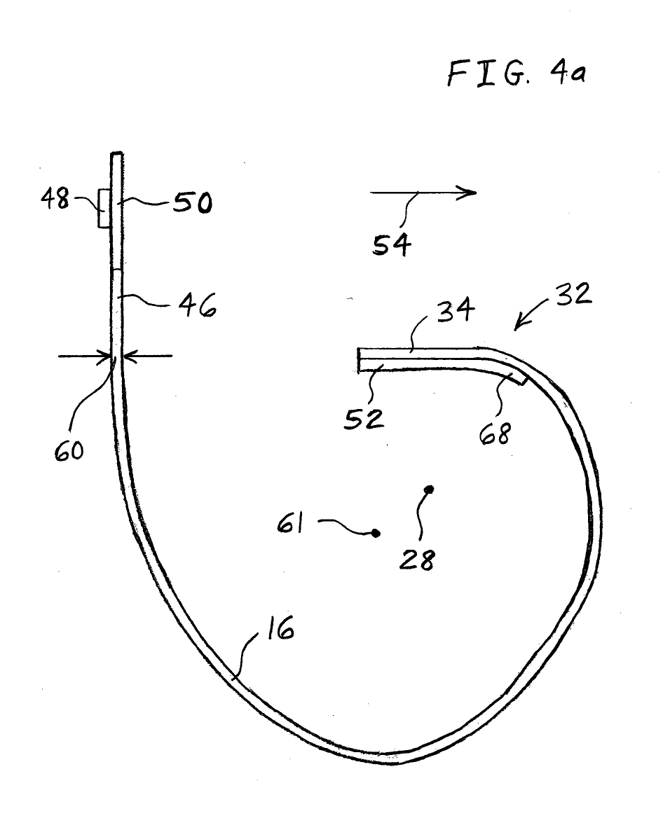

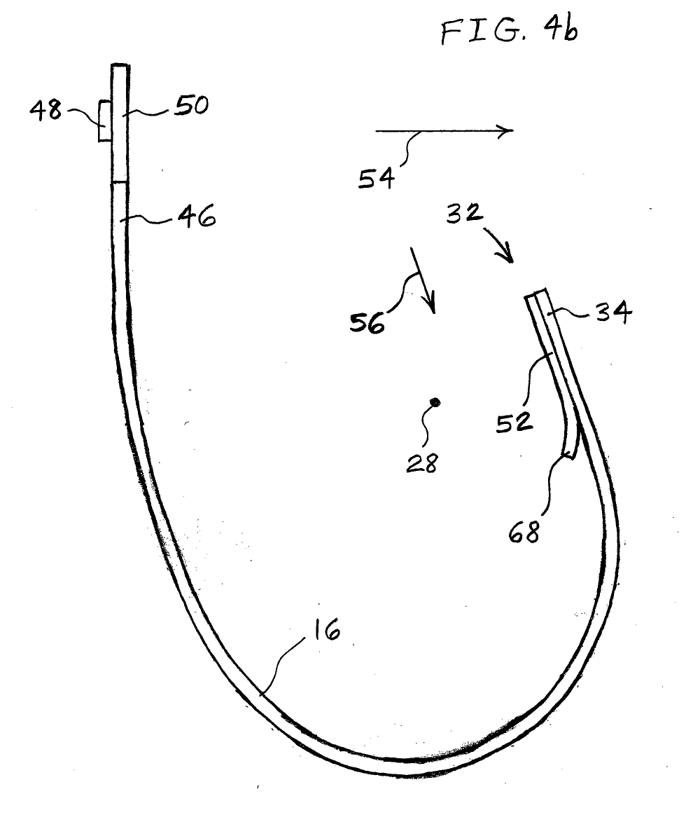

A second end 46 of cable 16 is electrically connected to camera control assembly circuit board 20 via an electrical connector 48 (FIG. 4a). End 46 is mechanically supported by a rigid backer 50. Rigid backer 50 may isolate and shield connector 48 from stress in cable 16.

Connectors 44, 48 may be double-row connectors (e.g., may have two rows of electrical terminals) and may be designed to carry signals of high frequencies. The connector housing on the rigid backer end may fit a mating connector of board 20 to thereby maintain orientation.

FIG. 4a illustrates the profile of cable 16 and shelf 52 when camera 26 is in the tilt position wherein a lens of camera 26 is pointed substantially in a horizontal direction indicated by arrow 54. FIG. 4b, in contrast, illustrates the profile of cable 16 and shelf 52 when camera 26 is in the tilt position wherein a lens of camera 26 is pointed nearly in a substantially vertically downward direction indicated by arrow 56. In one embodiment, the tilt positions of FIGS. 4a-b represent the opposite extremes that may be achieved by camera 26. As can be seen in comparing FIGS. 4a-b, end 46 of cable 16 and connector 48 remain substantially unmoved throughout the tilting movements of camera 26. End 32 of cable 16, in contrast, follows the tilting movements of camera 26. Moreover, cable 16 essentially uncoils as camera 26 tilts from the position of FIG. 4a to the position of FIG. 4b, and coils and recoils as camera 26 tilts from the position of FIG. 4b to the position of FIG. 4a. Because the coiling and uncoiling movement of cable 16 are in a plane substantially perpendicular to a width direction 58 (FIG. 3a) of cable 16, cable 16 and its connections on its opposite ends to connector 48 and shelf 52 are substantially unstressed during the coiling and uncoiling movement.

As can be seen in FIGS. 4a and 4b, the overall shape of cable 16 when viewed along tilt axis 28 is J-shaped regardless of the tilt position of camera 26. The shape of cable 16 may also be described as a partial loop, as a partial circle, as hook-shaped, or as coil-shaped.

In one embodiment, width 58 of cable 16 is at least twice as great as a thickness 60 (FIG. 4a) of cable 16. In other embodiments, width 58 is at least four, eight, twelve and twenty times, respectively, as great as thickness 60. More generally, however, the ratio of width 58 to thickness 60 may be such that cable 16 may repeatedly uncoil and recoil in the planes of FIGS. 4a-b with a low level of mechanical stress on cable 16 and on connectors 44 and 48.

In one embodiment, flex tape cable 16 may be formed of one or more thick conductive filaments sandwiched between thin non-conductive layers. Two such example filaments 59 are schematically and fragmentarily represented in FIG. 3a by dashed lines in extension 36, elbow 34, and body 63 of cable 16. As shown in FIG. 3b, conductive filaments 59 may be sandwiched between two layers 57 of film and adhesive, and may disposed near or coincident with a neutral axis 38, thereby reducing stress on cable 16 when cable 16 is flexed. For example, when cable 16 is flexed in a plane perpendicular to tilt axis 28, one of layers 57 may be in compression, and the other one of layers 57 may be in expansion. It is to be understood that FIG. 3b is merely a fragmentary view of a portion of cable 16 along width 58, and cable 16 may include many more conductive filaments 59 along width 58. In one embodiment, filaments 59 are in the form of low voltage differential signaling (LVDS) pairs which constitute controlled impedance microstrip transmission lines and which accommodate low voltage differential signaling. Such controlled impedance microstrip transmission lines may enable the flex loop to transmit high frequency signals.

The flex tape cable's semicircle shape or J-shape may be positioned such that tilt axis 28 is close to the geometric center of the loop formed by cable 16. In one embodiment, tilt axis 28 is closer to the geographical center of the profile of cable 16 than to any part of cable 16, as is the case in FIGS. 4a-b. For example, as shown in FIG. 4a, the distance between tilt axis 28 and a geometric center 61 of the profile of cable 16 is smaller than a smallest distance between tilt axis 28 and cable 16. The bend radius of cable 16 may be large enough to keep the stress on the conductive filament below a fatigue limit.

In one embodiment, cable 16 includes two layers of conductive filaments which are separated by a nonconductive layer used for low voltage differential signaling (LVDS) pairs. In one embodiment, the conductive filaments may be in the form of LVDS pairs. Each LVDS pair may be aligned one above the other (e.g., aligned in the direction of thickness 60) for more effective and/or less electrically noisy high frequency operation.

As camera assembly 12 undergoes tilting movement in a range between the two limits depicted in FIGS. 4a-b, cable 16 expands (e.g., “uncoils”) and contracts (e.g., “recoils”). End 32 of cable 16 may turn ninety degrees at circuit board 30 via extension 36 to engage connector 44 yet maintain the J-shape of cable 16. In one embodiment, a flex clamp 62 (FIG. 1) and a screw 64 may be used to fixedly attach elbow 34 of cable 16 to camera carriage shelf 52 adjacent to the ninety degree turn by extension 36. Evenly distributed clamping force exerted on elbow 34 by flex clamp 62 also evenly distributes stress in cable 16 and inhibits any stress in cable 16 from being transferred to connector 44 via extension 36. A curved or arcuate portion 66 of flex clamp 62 and a curved or arcuate portion 68 (FIG. 3a) of camera shelf 52 may provide lower stress orientation of cable 16 in an arcuate direction, as arcuate portions 66, 68 may conform to a curvature of cable 16. FIG. 4b depicts an embodiment in which arcuate portion 66 of flex clamp 62 is omitted (e.g., elbow 34 is affixed to shelf 52 by other means), and thus cable 16 does not conform to arcuate portion 68 of camera shelf 52.

The static or stationary extension 36 may have a very low profile or vertical height, making it easier for arrangement 10 to fit into the volume of the hemispheric dome window. A longitudinal axis 69 (FIG. 3a) of connector 44 to which extension 36 connects may be perpendicular to a longitudinal axis 71 (FIG. 1) of connector 48.

At the opposite end 46 of cable 16, end 46 extends above, away from, and/or tangent to the loop or semi-loop formed by the remainder of cable 16. Thereby, cable 16 is substantially straight and uncurved at end 46. Thus mechanical stress may be reduced at end 46 of cable 16 where end 46 connects to connector 48.

The combination of the above elements results in a high reliability, high frequency system that fits into the conventional hemispheric window volume normally occupied by pan-tilt-zoom surveillance dome cameras. Specifically, the ninety degree bend in end 32 of cable 16 embodied by elbow 34 and extension 36 provides a reduced vertical height. However, the scope of the present invention encompasses embodiments not including the low-profile 90 degree bend at the camera end of the cable. In these embodiments, the rigid backer and connector that are employed on the control assembly end of the cable may be duplicated on the camera end of the cable.

FIG. 3c illustrates another embodiment of a flex loop cable 216 suitable for use in the camera tilt flex loop arrangement of FIG. 1. Conductive filaments 259 may be sandwiched between layer 257a of film and adhesive and spacer 257b. A ground plane conductor 261 may be sandwiched between spacer 257b and another layer 257c of film and adhesive. Spacer 257b may disposed near or coincident with a neutral axis 238, thereby reducing stress on cable 216 when cable 216 is flexed, similarly to the embodiment of FIG. 3b. It is to be understood that FIG. 3c is merely a fragmentary view of a portion of cable 216 along width 258, and cable 216 may include many more conductive filaments 259 along width 258. In one embodiment, filaments 259 are in the form of LVDS pairs which constitute controlled impedance microstrip transmission lines and which accommodate low voltage differential signaling.

Conductors 259 may each be of the same width W_{c} and thickness T_{c} as conductors 59. Conductors 259 may also be separated by a same distance S_{c} as conductors 59.

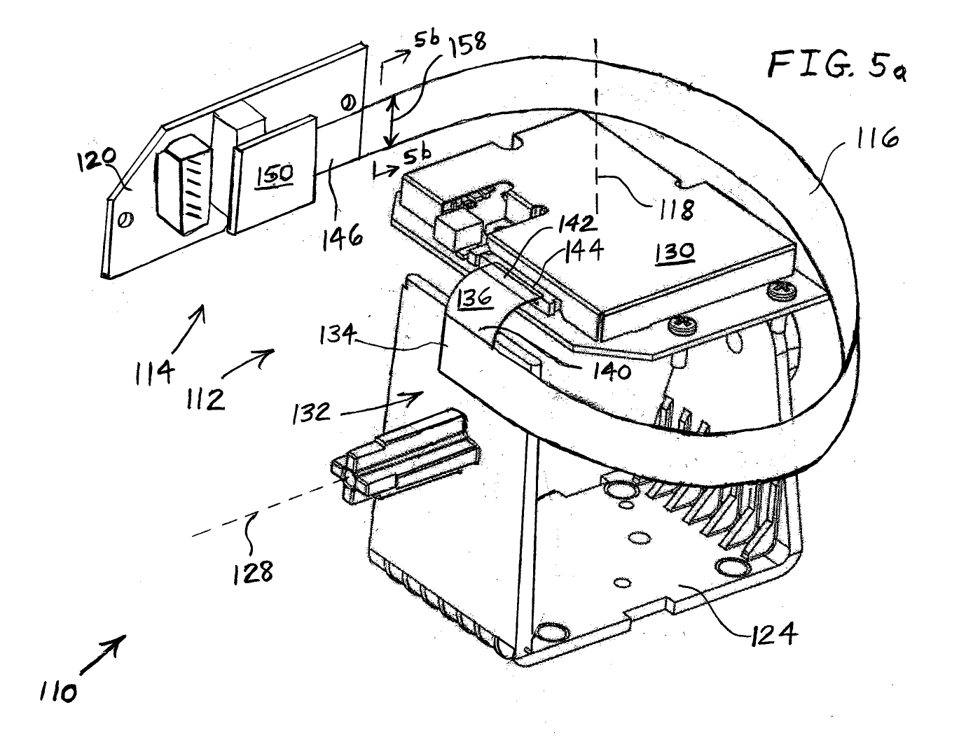

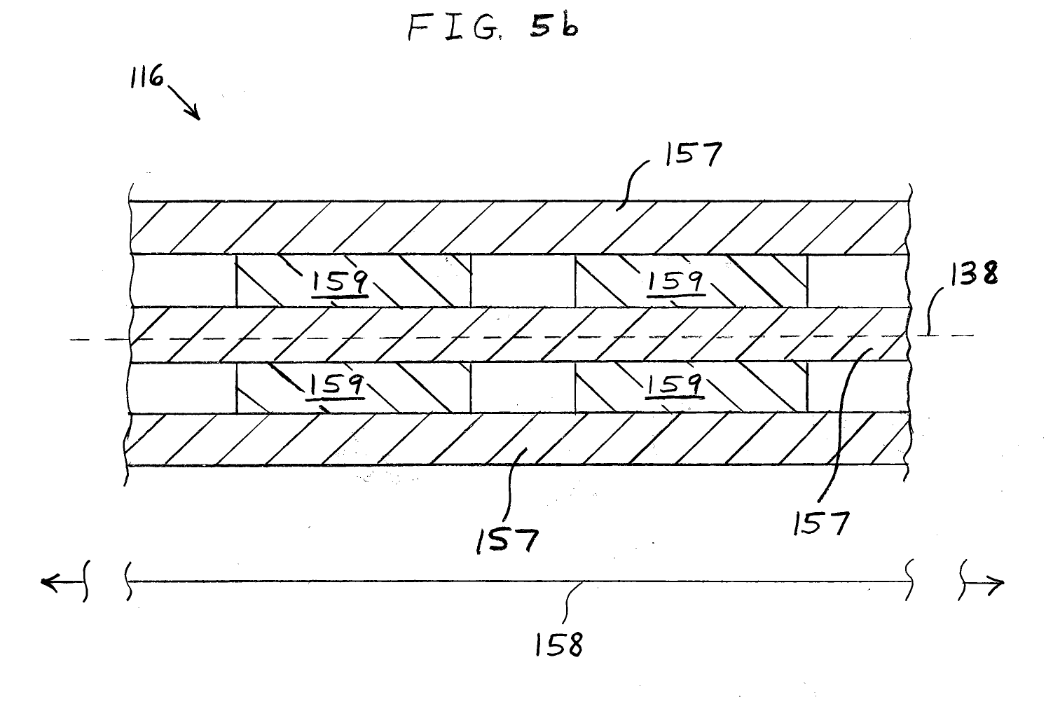

The present invention may further be applied to a flex loop cable arrangement that accommodates rotation or pivoting of a camera assembly about a pan axis instead of, or in addition to, rotation or pivoting about a tilt axis. In FIG. 5a, there is illustrated one embodiment of a camera pan flex loop arrangement 110 of the present invention including a camera assembly 112 and a camera control assembly 114 electrically connected together by a flex loop cable 116. Camera control assembly 114 includes a circuit board 120 that may be electrically connected and/or attached to a slip ring, such as slip ring 22, via a slip ring connector (not shown). Thus, a low stress loop in the form of cable 116 is provided between the slip ring and camera assembly 112. Camera control assembly 114 may be laterally offset from a pan axis 118 and/or a tilt axis 128. In one embodiment, assembly 114 is offset from pan axis 118 and/or tilt axis 128 by four inches or more. In another embodiment, assembly 114 is offset from pan axis 118 and/or tilt axis 128 by six inches or more. Thus, camera control assembly 114 is disposed “outboard” relative to pan axis 118 and/or tilt axis 128. The outboard or laterally offset position of assembly 114 and the looped configuration of cable 116 provide arrangement 110 with a reduced height and/or width/depth.

A carriage, frame or housing 124 of camera assembly 112 is fixed to a camera, such as camera 26, and a bearing (not shown) to rotate, pivot or tilt about tilt axis 128. Carriage 124 and the camera may also rotate, pivot or pan about pan axis 118. Thus, the entire camera assembly 112, including the camera, a camera assembly circuit board 130, and carriage 124 may be tiltable in both clockwise and counterclockwise directions about tilt axis 128, and may be subject to panning movements in both clockwise and counterclockwise directions about pan axis 118. Camera interface printed circuit board 130 is fixed to, and tilts and pans with, the camera and camera carriage 124. In contrast with camera assembly circuit board 130, camera control assembly printed circuit board 120 does not tilt or pan, but rather remains stationary throughout the movement of board 130.

Flex loop cable 116, which may be referred to as “a flex tape circuit,” or a “flex cable tape,” engages connectors on both the camera interface and on the camera control printed circuit board. More particularly, a first end 132 of cable 116 includes an elbow 134 having an extension 136 oriented at a right angle to a longitudinal axis 138 of cable 116. Extension 136 is arcuate, and has a proximal end 140 connected to a side edge of elbow 134. A distal end 142 of extension 136 is electrically connected to a connector 144 of camera assembly circuit board 130. Elbow 134 may be fixedly attached to carriage 124 by any means, such as screws, rivets, a clamp, adhesive, etc.

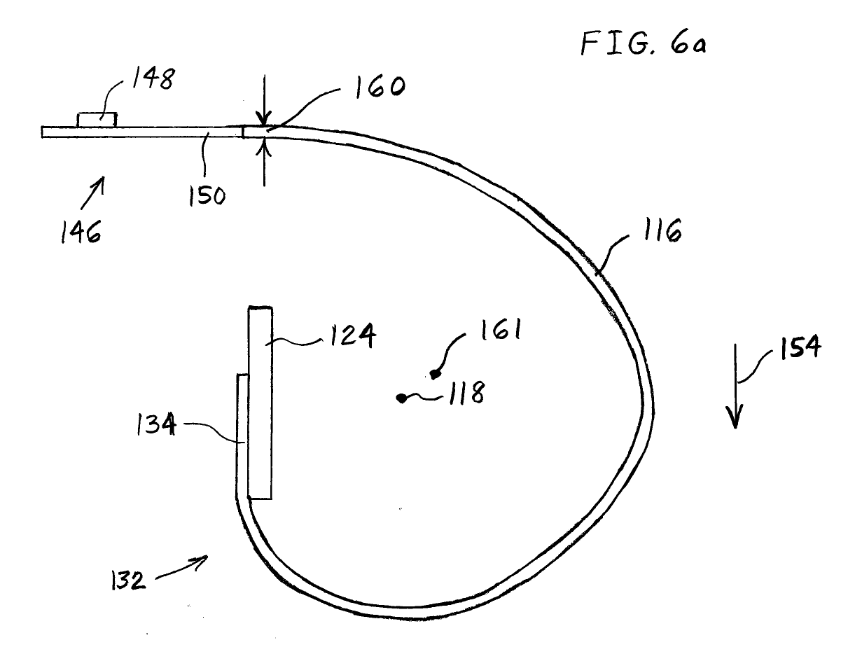

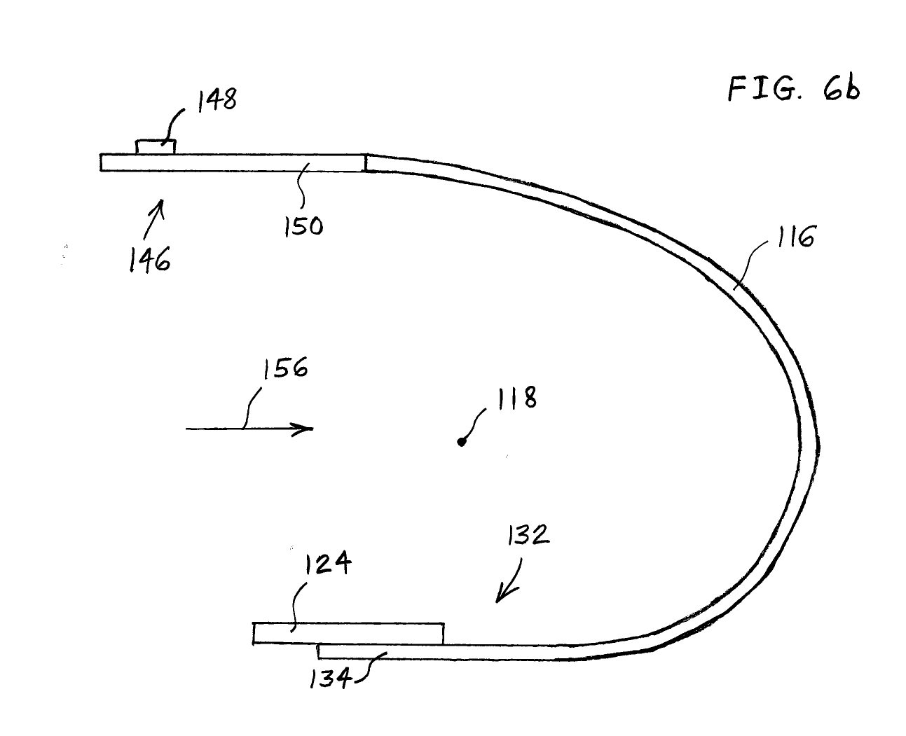

A second end 146 of cable 116 is electrically connected to camera control assembly circuit board 120 via an electrical connector 148 (FIG. 6a). End 146 is mechanically supported by a rigid backer 150. Rigid backer 150 may isolate and shield connector 148 from stress in cable 116.

Connectors 144, 148 may be double-row connectors (e.g., may have two rows of electrical terminals) and may be designed to carry signals of high frequencies. The connector housing on the rigid backer end may fit a mating connector of board 120 to thereby maintain orientation.

FIG. 6a illustrates the profile of cable 116 and carriage 124 when the camera is in the fully clockwise position shown in FIG. 5a wherein a lens of the camera is pointed in a direction indicated by arrow 154. FIG. 6b, in contrast, illustrates the profile of cable 116 and carriage 124 when the camera is in the fully counterclockwise position wherein a lens of the camera is pointed in a direction indicated by arrow 156. In one embodiment, the pan positions of FIGS. 6a-b represent the opposite extremes that may be achieved by a camera that is positioned in a corner of a room and that thus has a ninety degree range of panning movement. As can be seen in comparing FIGS. 6a-b, end 146 of cable 116 and connector 148 remain substantially unmoved throughout the tilting movements of the camera. End 132 of cable 116, in contrast, follows the panning movements of the camera. Moreover, cable 116 essentially uncoils as the camera pans from the position of FIG. 6a to the position of FIG. 6b, and recoils as the camera pans from the position of FIG. 6b to the position of FIG. 6a. Because the coiling and uncoiling movement of cable 116 are in a plane substantially perpendicular to a width direction 158 (FIG. 5a) of cable 116, cable 116 and its connections on its opposite ends to connector 148 and carriage 124 are substantially unstressed during the coiling and uncoiling movement.

As can be seen in FIGS. 6a and 6b, the overall shape of cable 116 when viewed along pan axis 118 is J-shaped regardless of the pan position of the camera. The shape of cable 116 may also be described as a partial loop, as a partial circle, or as hook-shaped.

In one embodiment, width 158 of cable 116 is at least twice as great as a thickness 160 (FIG. 6a) of cable 116. In other embodiments, width 158 is at least four, eight, twelve and twenty times, respectively, as great as thickness 160. More generally, however, the ratio of width 158 to thickness 160 may be such that cable 116 may repeatedly uncoil and recoil in the planes of FIGS. 6a-b with a low level of mechanical stress on cable 116 and on connectors 144 and 148.

In one embodiment, flex tape cable 116 may be formed of one or more thick conductive filaments sandwiched between thin non-conductive layers. For example, as shown in FIG. 5b, two conductive filaments 159 may be sandwiched between an upper layer 157 and a middle layer 157 of film and adhesive, and another two conductive filaments 159 may be sandwiched between the middle layer 157 and a lower layer 157 of film and adhesive. In one embodiment, filaments 159 are in the form of LVDS pairs which constitute controlled impedance microstrip transmission lines and which accommodate low voltage differential signaling. Such controlled impedance microstrip transmission lines may enable the flex loop to transmit high frequency signals.

Filaments 159 may be centered around or relative to a neutral axis 138, thereby reducing stress on cable 116 when cable 116 is flexed. For example, when cable 116 is flexed in a plane parallel to tilt axis 128, one of the upper and lower layers 157 may be in compression, and the other one of the upper and lower layers 157 may be in expansion. It is to be understood that FIG. 5b is merely a fragmentary view of a portion of cable 116 along width 158, and cable 116 may include many more conductive filaments 159 along width 158.

The flex tape cable's semicircle shape or J-shape is positioned such that pan axis 118 is close to the geometric center of the loop formed by cable 116. In one embodiment, pan axis 128 is closer to the geometric center of the profile of cable 116 than to any part of cable 116, as is the case in FIGS. 6a-b. For example, as shown in FIG. 6a, a distance between pan axis 118 and a geometric center 161 of the profile of cable 116 may be less than a smallest distance between pan axis 118 and cable 116. The bend radius of cable 116 may be large enough to keep the stress on the conductive filament below a fatigue limit.

In one embodiment, cable 116 includes two layers of conductive filaments which are separated by a nonconductive layer used for LVDS pairs. In one embodiment, the conductive filaments may be in the form of LVDS pairs. Each LVDS pair may be aligned one above the other (e.g., aligned in the direction of thickness 160) for more effective and/or less electrically noisy high frequency operation.

As camera assembly 112 undergoes panning movement in a range between the two limits depicted in FIGS. 6a-b, cable 116 expands (e.g., “uncoils”) and contracts (e.g., “recoils”). End 132 of cable 116 may turn ninety degrees at circuit board 130 via extension 136 to engage connector 144 yet maintain the J-shape of cable 116.

The static or stationary extension 136 may have a very low profile or vertical height, making it easier for arrangement 110 to fit into the volume of the hemispheric dome window. The longitudinal axis of connector 144 to which extension 136 connects may be perpendicular to the longitudinal axis of connector 148.

Other features of arrangement 110 are substantially similar to the features of arrangement 10, and thus are not described in detail herein in order to avoid needless repetition.

As described above, cables 16, 116, 216 may be controlled impedance microstrip transmission lines in that their impedances may be adjusted by modifying one or more of the internal dimensions of the cable. For example, the impedance may be affected by the conductor size (e.g., width W_{c} and thickness T_{c}); microstrip pair spacing S_{c}; and thickness Ts of spacer 257b, which affects the dielectric properties of the spacer vis-a-vis the adjacent ground plane conductor 261. It has been found that, in order to maintain a same impedance value for the cable, but achieve lower overall thickness and greater flexibility in the cable, the thickness of both the conductors and the spacer may be reduced. In one embodiment, conductor thickness T_{c} is approximately between 18 μm and 36 μm, and spacer thickness Ts is approximately between 0.002 inch and 0.003 inch. After making an adjustment to conductor thickness T_{c} and spacer thickness Ts, further modification of the impedance may be achieved by adjusting the conductor width We and spacing Sc.

While this invention has been described as having an exemplary design, the present invention may be further modified within the spirit and scope of this disclosure. This application is therefore intended to cover any variations, uses, or adaptations of the invention using its general principles.

What is claimed is:

1. A surveillance camera arrangement comprising:
a camera assembly tiltable about a tilt axis and having a first electrical connector;
a second electrical connector; and
a flat cable including first and second opposite ends connected to the first and second electrical connectors, respectively, the cable having a thickness, and a width at least twice as great as the thickness, the cable being bent into a J-shape wherein a width direction of the cable is substantially parallel to the tilt axis of the camera assembly.

2. The arrangement of claim 1 wherein the cable is bent into a J-shape around the tilt axis.

3. The arrangement of claim 1 wherein the cable is configured to recoil and uncoil about the tilt axis along with tilting movements of the camera assembly.

4. The arrangement of claim 1 wherein the first end of the cable includes an extension projecting from a body of the cable at a right angle, a distal end of the extension being connected to the first electrical connector, a proximal end of the extension being connected to the body of the cable.

5. The arrangement of claim 4 wherein the proximal end of the extension is connected to an elbow of the cable, the elbow being clamped to a frame of the camera assembly.

6. The arrangement of claim 5 wherein the elbow is at a different vertical level than the first connector, the extension being S-shaped.

7. The arrangement of claim 1 further comprising a camera control circuit connected to the second electrical connector.

8. A surveillance camera arrangement comprising:
a camera assembly tiltable about a tilt axis; and
a flat cable including first and second opposite ends, a first said end connected to the camera assembly, a second said end connected to a fixed structure, the cable having a thickness, and a width at least twice as great as the thickness, the cable being bent into a J-shape wherein a width direction of the cable is substantially parallel to the tilt axis of the camera assembly, and the cable substantially surrounds the tilt axis.

9. The arrangement of claim 8 wherein the camera assembly has a first electrical connector, the first end of the cable being electrically connected to the first electrical connector, the fixed structure having a second electrical connector, the second end of the cable being electrically connected to the second electrical connector.

10. The arrangement of claim 8 wherein the fixed structure comprises a circuit board assembly.

11. The arrangement of claim 8 wherein the first end of the cable includes an extension interconnecting a body of the cable and the camera assembly, the extension extending at an angle of approximately ninety degrees relative to a longitudinal axis of the body of the cable, a distal end of the extension being connected to an electrical connector of the camera assembly, a proximal end of the extension being connected to the body of the cable.

12. The arrangement of claim 11 wherein the proximal end of the extension is connected to an elbow of the cable, the elbow being clamped to a shelf of the camera assembly, the shelf being substantially perpendicular to an upstanding wall of a frame of the camera assembly.

13. The arrangement of claim 12 wherein the elbow is at a vertical level that is lower than the electrical connector of the camera assembly, the extension having a serpentine profile.

14. The arrangement of claim 8 wherein the tilt axis is closer to a geometric center of a J-shaped profile of the cable than to any part of the cable.

15. A surveillance camera arrangement comprising:
a camera assembly tiltable about a tilt axis; and
a flat cable including first and second opposite ends, the first end having an extension oriented at a substantially right angle to a longitudinal axis of the cable, a distal end of the extension connected to an electrical connector of the camera assembly, a proximal end of the extension connected to an elbow of the cable, the elbow being fixedly attached to the camera assembly, the second end of the cable being connected to a fixed structure, the cable having a thickness, and a width at least twice as great as the thickness, the cable being bent into a J-shape wherein a width direction of the cable is substantially parallel to the tilt axis of the camera assembly.

16. The arrangement of claim 15 wherein the cable substantially surrounds the tilt axis.

17. The arrangement of claim 15 wherein the fixed structure has a second electrical connector, the second end of the cable being electrically connected to the second electrical connector.

18. The arrangement of claim 15 wherein the fixed structure comprises a circuit board assembly.

19. The arrangement of claim 15 wherein the first end of the cable includes an extension electrically interconnecting a body of the cable and the camera assembly, the extension extending at an angle of approximately ninety degrees relative to a longitudinal axis of the body of the cable, a distal end of the extension being electrically connected to the electrical connector of the camera assembly, a proximal end of the extension being electrically connected to a plurality of conductive filaments in the body of the cable, the conductive filaments being sandwiched between two non-electrically conductive layers and being configured to accommodate low voltage differential signaling (LVDS).

20. The arrangement of claim 19 wherein the proximal end of the extension is electrically connected to an elbow of the cable, the elbow being mechanically clamped to a shelf of the camera assembly, the shelf being substantially perpendicular to an upstanding wall of a frame of the camera assembly, the shelf including an arcuate portion configured to conform to a curvature of the cable.
